(19) United States
(12) Patent Application Publication
(10) Pub. No.: US 2025/0086906 A1
(43) Pub. Date: Mar. 13, 2025

(54) METHOD AND AN ELECTRONIC DEVICE FOR CONTEXTUAL BASED ENHANCEMENT OF EXTENDED REALITY SCENE

(71) Applicant: Samsung Electronics Co., Ltd., Suwon-si (KR)

(72) Inventors: Raghavan VELAPPAN, Bengaluru (IN); Abhishek CHANDEL, Bengaluru (IN); Lokesh Rayasandra BOREGOWDA, Bengaluru (IN); Lakshmi Priya MURALEEDHARAN, Kozhikode (IN); Pankaj BANSAL, Bengaluru (IN); S KRITHIHA, Bengaluru (IN); Gyanendu SHEKHAR, Bengaluru (IN)

(21) Appl. No.: 18/896,160

(22) Filed: Sep. 25, 2024

Related U.S. Application Data
(63) Continuation of application No. PCT/KR2024/003352, filed on Mar. 18, 2024.

(30) Foreign Application Priority Data
Sep. 11, 2023 (IN) 202341060877

(51) Int. Cl. G06T 19/00

(52) U.S. Cl. CPC G06T 19/006

(57) ABSTRACT

A method for contextual based enhancement of an extended reality (XR) scene by an electronic device is provided. The method includes detecting at least one static object and at least one dynamic object in an XR scene, determining context information of the at least one dynamic object, determining whether a correlation between the context information of the dynamic object and the contextual meta information corresponding to the dynamic object is available in a contextual database, and applying the contextual meta information from the contextual database to the at least one dynamic object.

### CROSS-REFERENCE TO RELATED APPLICATION(S)

This application is a continuation application, claiming priority under § 365 (c), of an International application No. PCT/KR2024/003352, filed on Mar. 18, 2024, which is based on and claims the benefit of an Indian Patent Application number 202341060877, filed on Sep. 11, 2023, in the Indian Intellectual Property Office, the disclosure of which is incorporated by reference herein in its entirety.

### TECHNICAL FIELD

The disclosure relates to the field of extended Reality (XR) systems and methods. More particularly, the disclosure to a method and an electronic device for contextual based enhancement of an extended reality scene.

### BACKGROUND

For generating an XR experience, data are generated in real time. In an example, consider, the user visits a virtual museum. In the virtual museum, a lot of objects (e.g. cultural history, natural history, botanical and zoological gardens, craft, fine arts or the like) are static objects and a user's movement is dynamic objects. In order to generate the XR scene, the existing method generates the XR scene by combining the static object and the dynamic object in the real time. Hence, the XR scene generation consumes a lot of resources (e.g., processing power, central processing unit (CPU) usage or the like). Further, various existing methods and existing systems are used for enhancing an XR scene, but the existing methods and existing system do not disclose about a contextual based enhancement of the XR scene. Further, existing methods and existing systems have own advantages and disadvantages for improving/enhancing the XR scene in terms of cost, quality, user experience, processing time, data usage or the like.

It is desired to address the above mentioned disadvantages or other short comings or at least provide a useful alternative.

The above information is presented as background information only to assist with an understanding of the disclosure. No determination has been made, and no assertion is made, as to whether any of the above might be applicable as prior art with regard to the disclosure.

### OBJECTS OF THE INVENTION

Aspects of the disclosure are to address at least the above-mentioned problems and/or disadvantages and to provide at least the advantages described below. Accordingly, an aspect of the disclosure is to provide a method and an electronic device for contextual based enhancement of an XR scene.

An object aspect of the disclosure is to provide retrieve meta information for faster rendering of the XR scene.

An object aspect of the disclosure is to provide determine whether a correlation between context information of a dynamic object and contextual meta information corresponding to the dynamic object is available in a contextual database.

An object aspect of the disclosure is to provide a complete rendering of the dynamic object in the XR scene by applying the contextual meta information to the dynamic object in the XR scene, when the correlation between the context information of the dynamic object and the contextual meta information corresponding to the dynamic object is available in the contextual database.

An object aspect of the disclosure is to provide a partial rendering of the dynamic object in the XR scene by applying non-contextual meta information of the dynamic object, when the correlation between the context information of the dynamic object and the contextual meta information corresponding to the dynamic object is not available in the contextual database.

An object aspect of the disclosure is to provide store the contextual meta information of each object of a plurality of objects in the contextual database.

Additional aspects will be set forth in part in the description which follows and, in part, will be apparent from the description, or may be learned by practice of the presented embodiments.

### SUMMARY

In an embodiment, a method for contextual based enhancement of an XR scene in an electronic device is provided. The method includes detecting, by the electronic device, at least one static object and at least one dynamic object in an XR scene, determining, by the electronic device, context information of the at least one dynamic object, determining, by the electronic device, whether a correlation between the context information of the at least one dynamic object and contextual meta information corresponding to the at least one dynamic object is available in a contextual database, and applying, by the electronic device, the contextual meta information from the contextual database to the at least one dynamic object.

In an embodiment, an electronic device for contextual based enhancement of an XR scene is provided. The electronic device includes a display including a touchscreen, memory storing one or more computer programs, and one or more processors communicatively coupled to the display, and the memory, wherein the one or more computer programs include computer-executable instructions that, when executed by the one or more processors, cause the electronic device to detect at least one static object and at least one dynamic object in an XR scene, determine context information of the at least one dynamic object, determine whether a correlation between the context information of the at least one dynamic object and contextual meta information corresponding to the at least one dynamic object is available in a contextual database stored in the memory, and apply the contextual meta information from the contextual database to the at least one dynamic object.

In an embodiment, one or more non-transitory computer-readable storage media storing one or more computer programs including computer-executable instructions that, when executed by one or more processors of an extended reality (XR) device, cause the electronic device to perform operations are provided. The operations include detecting, by the electronic device, at least one static object and at least one dynamic object in an XR scene, determining, by the electronic device, context information of the at least one dynamic object, determining, by the electronic device, whether a correlation between the context information of the at least one dynamic object and contextual meta information corresponding to the at least one dynamic object is available in a contextual database, and applying, by the electronic device, the contextual meta information from the contextual database on to the at least one dynamic object.

Advantages, and salient features of the disclosure will become apparent to those skilled in the art from the following detailed description, which, taken in conjunction with the annexed drawings. discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 shows various hardware components of an electronic device, according to an embodiment of the disclosure;

FIG. 2 is a flow chart illustrating a method for contextual based enhancement of an XR scene in the electronic device, according to an embodiment of the disclosure;

FIG. 3 is an example flow chart illustrating a method for contextual based enhancement of the XR scene in the electronic device, according to an embodiment of the disclosure;

FIG. 4 is an example flow chart illustrating a method for contextual based enhancement of the XR scene, according to an embodiment of the disclosure;

FIG. 5 is an example illustration in which a static object and a dynamic object are detected in the XR scene, according to an embodiment of the disclosure;

FIG. 6 is an example illustration in which surface mapping is depicted, according to an embodiment of the disclosure;

FIGS. 7 and 8 are example illustrations in which depth mapping is depicted, according to an embodiment of the disclosure;

FIG. 9 is an example illustration in which light mapping is depicted, according to an embodiment of the disclosure;

FIG. 10 is an example illustration in which spatial mapping is depicted for the XR environment including the furniture, wall, and window, according to an embodiment of the disclosure;

FIG. 11 is an example illustration in which the proposed method is implemented in an indoor meeting room setup, according to an embodiment of the disclosure;

FIG. 12 is an example illustration in which the proposed method is implemented in an interactive sculpting application, according to an embodiment of the disclosure;

FIG. 13 is an example illustration in which the proposed method is implemented in an AR emoji play mode, according to an embodiment of the disclosure; and

FIG. 14 is an example illustration in which the proposed method is implemented in an AR Doodle application, according to an embodiment of the disclosure.

The same reference numerals are used to represent the same elements throughout the drawing.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

In an embodiment, the XR scene may include at least one of the digital environment presented to the user or composite view presented to the user, which overlays virtual elements onto the real-world environment captured by the device's camera.

In an embodiment, the surface map may refer to a representation of the surfaces or geometry of objects in the physical environment or virtual scene.

In an embodiment, the depth map may refer to a 2D representation of the distance or depth of objects in the scene relative to the camera.

In an embodiment, the light map may refer to a texture or data representation that stores information about lighting conditions in the scene.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The embodiments herein achieve a method for contextual based enhancement of an XR scene in an electronic device. The method includes detecting, by the electronic device, a static object and a dynamic object in an XR scene. Further, the method includes determining, by the electronic device, context information of the dynamic object. Further, the method includes determining, by the electronic device, whether a correlation between the context information of the dynamic object and contextual meta information corresponding to the dynamic object is available in a contextual database. In an embodiment, the method includes displaying a complete rendering of the dynamic object in the XR scene by applying the contextual meta information to the dynamic object in the XR scene, when the correlation between the context information of the dynamic object and the contextual meta information corresponding to the dynamic object is available in the contextual database. In an embodiment, the method includes displaying a partial rendering of the dynamic object in the XR scene by applying non-contextual meta information of the dynamic object, when the correlation between the context information of the dynamic object and the contextual meta information corresponding to the dynamic object is not available in the contextual database.

Unlike conventional methods and systems, the electronic device is used in an indoor environment and in most probability in the same environment (in general). Based on the proposed method, the creation of the contextual database is based on location and user profile combination by using a depth map, a scene map etc. The proposed method can be used to fetch the stored information by using visual features mapping from the contextual database. By using, a refinement procedure, the method can be used to improve the XR data for a current session. The proposed method improves the rendering quality and scene quality in an accurate and fast manner without wasting the resource (e.g., CPU usage, processing power or the like). The proposed method is used for storing the meta data information about the scene itself by using a light map, the depth map and the surface map. The proposed method can be used to improve the performance and quality of the XR scene when the XR session is repeated in a same place.

The method can be implemented in an XR Framework, XR engine, a Virtual Studio Technology (VST) Framework. The method can also be implemented in a standalone XR applications like augmented reality (AR) Doodle.

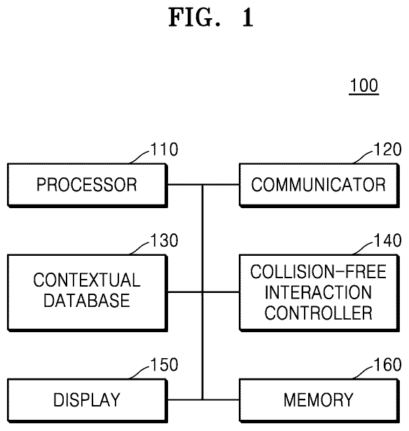

Referring now to the drawings, and more particularly to FIGS. 1 through 14, where similar reference characters denote corresponding features consistently throughout the figures, there are shown example embodiments.

FIG. 1 shows various hardware components of an electronic device (100), according to an embodiment of the disclosure. In an embodiment, the electronic device (100) may include an Extended Reality (XR) device. In an embodiment, The XR device also known as an Augmented Reality (AR) device, a Mixed Reality (MR) device, a Virtual Reality (VR) device, and a metaverse device. The electronic device (100) can be, for example, but not limited to a head mounted display, a smartphone, a foldable phone, a smart television (TV), a tablet, an immersive device, and an internet of things (IoT) device. In an embodiment, the electronic device (100) includes a processor (110), a communicator (120), a contextual database (130), contextual meta information controller (140), a display (150) and a memory (160). The processor (110) is communicatively coupled with the communicator (120), the contextual database (130), and the contextual meta information controller (140). The contextual database (130) is associated with the memory (160). The display (150) includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display (150) may also be a depth-aware display, such as a multi-focal display. In an embodiment, the display (150) is able to display, various contents (such as text, images, videos, icons, or symbols) to the user. In an embodiment, the display (150) may include a touchscreen and may receive a touch, gesture, proximity, or hovering input. The memory (160) may include a volatile and/or non-volatile memory. In an embodiment, the memory (160) may store commands or data related to at least one other component of the electronic device (100).

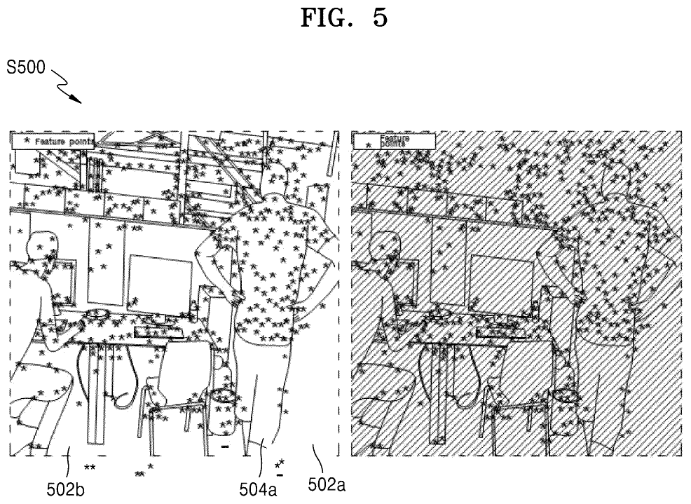

The contextual meta information controller (140) detects a static object and a dynamic object from a plurality of objects in the XR scene. The static object means there is no movement in the plurality of object. For example, as shown in FIG. 5, the static object can be, for example, but not limited to a floor, a ceiling and a wall. The dynamic object can be, for example, but not limited to people in the XR scene, a movable furniture, and objects that are not fixated to furniture. In an embodiment, the contextual meta information controller (140) detects a plurality of parameters associated with each object of the plurality of objects in the XR scene. The plurality of parameters can be, for example, but not limited to a type of object, and movements of the object in the XR scene. Further, the contextual meta information controller (140) determines the dynamic object from the plurality of objects based on the plurality of parameters.

Further, the contextual meta information controller (140) determines context information of the dynamic object. The context information can be, for example, but not limited to a current time, a location, a lighting condition, and user information. Further, the contextual meta information controller (140) determines whether a correlation between the context information of the dynamic object and contextual meta information corresponding to the dynamic object is available in the contextual database (130).

In an embodiment, when the correlation between the context information of the dynamic object and the contextual meta information corresponding to the dynamic object is available in the contextual database (130), the contextual meta information controller (140) displays a complete rendering of the dynamic object in the XR scene by applying the contextual meta information to the dynamic object in the XR scene.

In an embodiment, the contextual meta information controller (140) retrieves the contextual meta information from the contextual database (130) based on the correlation. The contextual meta information includes a surface map having a 3D reconstructed surface of the XR scene, a depth map having depth information of the XR scene, and a light map (or an environmental map) for the dynamic object. Further, the contextual meta information controller (140) refines the surface map, the depth map, and the light map based on the context information of the dynamic object. Further, the contextual meta information controller (140) displays the complete rendering of the dynamic object in the XR scene by applying the refined surface map, the refined depth map, and the refined light map to the dynamic object in the XR scene.

Further, the contextual meta information controller (140) stores the refined surface map, the refined depth map, and the refined light map of the dynamic object in the XR scene in the contextual database (130).

In an embodiment, when the correlation between the context information of the dynamic object and the contextual meta information corresponding to the dynamic object is not available in the contextual database (130), the contextual meta information controller (140) displays a partial rendering of the dynamic object in the XR scene by applying non-contextual meta information of the dynamic object.

Further, the contextual meta information controller (140) determines the plurality of objects available in the XR scene for a predefined time period. The predefined time period is set by the electronic device (100) or the user. The XR scene is associated with a predefined area comprising the plurality of objects. Further, the contextual meta information controller (140) determines the contextual meta information of each object of the plurality of objects. Further, the contextual meta information controller (140) stores the contextual meta information of each object of the plurality of objects in the contextual database (130).

In an embodiment, the contextual meta information controller (140) identifies the static object and the dynamic object in the XR scene. Further, the contextual meta information controller (140) determines the context information comprising the current time, the location, and the lighting in connection with the dynamic object in the XR scene. Further, the contextual meta information controller (140) obtains the correlation of the context information and the contextual meta information including the surface map, the texture, and the light map for the dynamic object from the contextual database (130). Further, the contextual meta information controller (140) applies obtained contextual meta information from the database on to the dynamic object for rendering the XR scene.

The contextual meta information controller (140) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (110) is configured to execute instructions stored in the memory (160) and to perform various processes. The communicator (120) is configured for communicating internally between internal hardware components and with external devices via one or more networks. The memory (160) also stores instructions to be executed by the processor (110). The memory (160) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (160) may, in some examples, be considered a non-transitory storage medium. The term “non-transitory” may indicate that the storage medium is not embodied in a carrier wave or a propagated signal. However, the term “non-transitory” should not be interpreted that the memory (160) is non-movable. In certain examples, a non-transitory storage medium may store data that can, over time, change (e.g., in Random Access Memory (RAM) or cache).

The contextual database (130) stores the information (e.g., image, video, file or the like) in a following manner (for example) such as Binary Large Object (BLOB) storage, file system storage, a Base64 encoding storage (for example). The BLOB is a binary data object that can be stored in the contextual database (130). The image or video is stored as the binary object in the contextual database (130) and can be retrieved and displayed as required. The image or video is stored on the file system storage, and the database includes a reference to the location of the file. When the user requests the image or video, the database retrieves the reference and serves the file from the file system storage. In the Base64 encoding storage, the image or video is encoded as a Base64 string and stored in a text column in the contextual database (130).

Further, at least one of a plurality of modules/controller may be implemented through an Artificial intelligence (AI) model using a data driven controller (not shown). The data driven controller can be a machine learning (ML) model based controller and a AI model based controller. A function associated with the AI model may be performed through the non-volatile memory, the volatile memory, and the processor (110). The processor (110) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 1 shows various hardware components of the electronic device (100) but it is to be understood that other embodiments are not limited thereon. In other embodiments, the electronic device (100) may include less or more number of components. Further, the labels or names of the components are used only for illustrative purpose and does not limit the scope of the invention. One or more components can be combined together to perform same or substantially similar function in the electronic device (100).

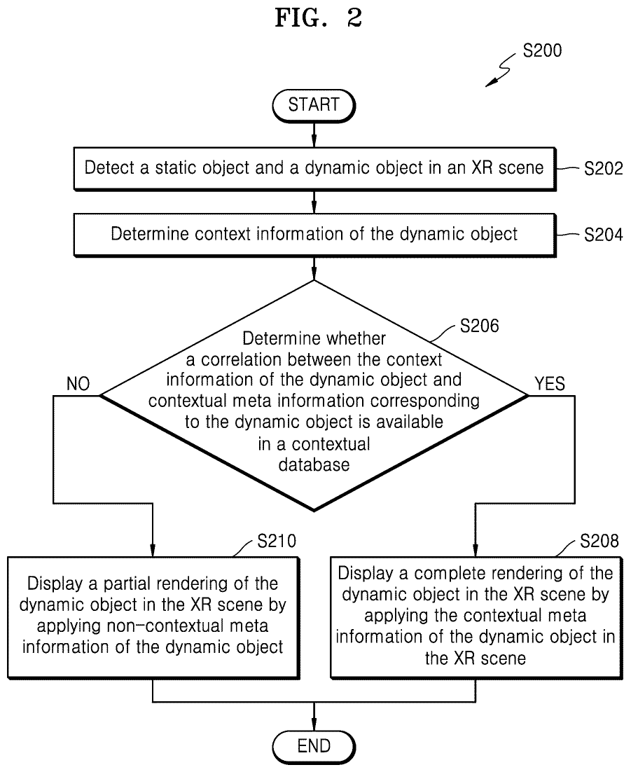

FIG. 2 is a flow chart at operation S200 illustrating a method for contextual based enhancement of the XR scene in the electronic device (100), according to an embodiment of the disclosure. The operations S202-S210 are performed by the contextual meta information controller (140).

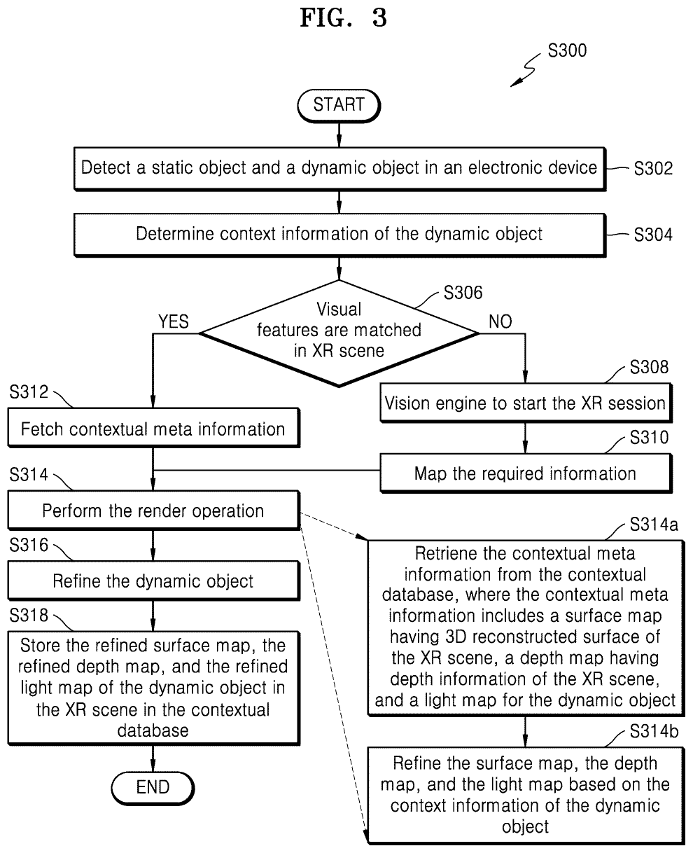

At operation S202, the method includes detecting the static object and the dynamic objects in the XR scene. At operation S204, the method includes determining the context information of the dynamic object. At operation S206, the method includes determining whether the correlation between the context information of the dynamic object and the contextual meta information corresponding to the dynamic object is available in the contextual database (130). In an embodiment, to determine whether the correlation between the context information of the dynamic object and the contextual meta information corresponding to the dynamic object is available in the contextual database (130), the method includes comparing visual features in the XR scene. The method for comparing visual features in the XR scene will be outlined in FIG. 3, operation S304. In an embodiment, at operation S208, the method includes displaying the complete rendering of the dynamic object in the XR scene by applying the contextual meta information to the dynamic object in the XR scene, when the correlation between the context information of the dynamic object and the contextual meta information corresponding to the dynamic object is available in the contextual database (130). In an embodiment, at operation S210, the method includes displaying a partial rendering of the dynamic object in the XR scene by applying non-contextual meta information of the dynamic object, when the correlation between the context information of the dynamic object and the contextual meta information corresponding to the dynamic object is not available in the contextual database (130).

FIG. 3 is an example flow chart at operation S300 illustrating a method for contextual based enhancement of the XR scene in the electronic device (100), according to an embodiment of the disclosure. The operations S302-S318 are performed by the contextual meta information controller (140).

At operation S302, the method includes start the XR application running in the electronic device (100). At operation S304, the method includes comparing visual features in the XR scene. In an embodiment, the comparison is done using a scale invariant feature transform (SIFT) technique. In an embodiment, comparing visual features in the XR scene includes matching S306 the visual features to the XR scene. At operation S306, the method includes determining whether the visual features are matched in the XR scene. In an embodiment, the method includes determining whether the visual features in the XR scene are matched to the contextual meta information by querying the contextual database (130). Upon determining that the visual features are not matched in the XR scene, at operation S308, the method includes using a vision engine to start the XR session. Further, the vision engine renders the scene with limited information about the scene. Further, the vision engine stores the required information in the contextual database (130) at the end of the session. At operation S310, the method includes mapping the required information.

Upon determining that the visual features are matched in the XR scene, at operation S312, the method includes fetching the contextual meta information. The contextual meta information includes the surface map having the 3D reconstructed surface of the XR scene, the depth map having depth information of the XR scene, and the light map for the dynamic object. At operation S314, the method includes performing the render operation. At operation S314a, the method includes retrieving the contextual meta information from the contextual database (130). The contextual meta information includes the surface map having the 3D reconstructed surface of the XR scene, the depth map having depth information of the XR scene, and the light map for the dynamic object. At operation S314b, the method includes refining the surface map, the depth map, and the light map based on the context information of the dynamic object. At operation S316, the method includes refining the dynamic object. At operation S318, the method includes storing the refined surface map, the refined depth map, and the refined light map of the dynamic object in the XR scene in the contextual database (130).

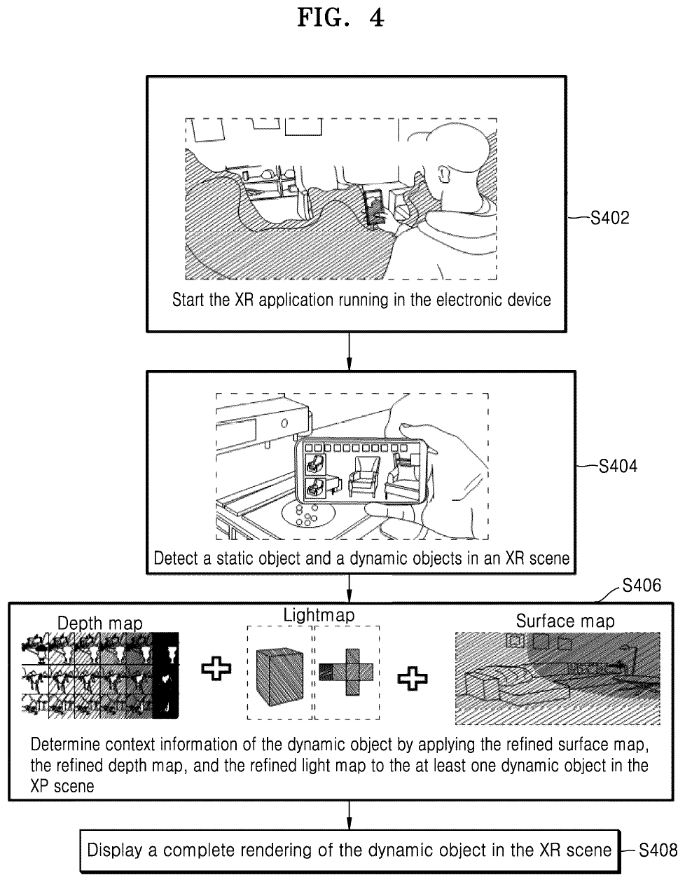

FIG. 4 is an example flow chart at operation S400 illustrating a method for contextual based enhancement of the XR scene, according to an embodiment of the disclosure. The operations S402-S408 are performed by the contextual meta information controller (140).

At operation S402, the method includes starting the XR application running in the electronic device (100). At operation S404, the method includes detecting the static object and the dynamic objects in the XR scene. At operation S406, the method includes determining the context information of the dynamic object by applying the refined surface map, the refined depth map, and the refined light map to the dynamic object in the XR scene. At operation S408, the method includes displaying the complete rendering of the dynamic object in the XR scene.

The proposed method can be used to fetch the stored information by using visual features mapping from the contextual database (130). By using the refinement procedure, the method can be used to improve the XR data for a current session. The proposed method improves the rendering quality and scene quality in an accurate and fast manner. The proposed method is used for storing the meta data about the scene itself by using a light map, a depth map and a surface map. The proposed method can be used to improve the performance and quality of the XR scene when the XR session is repeated in a same place.

FIG. 5 is an example illustration (S500) in which the static object and the dynamic object are detected in the XR scene, according to an embodiment of the disclosure. In an example, the static object and the dynamic object are detected in the XR scene using a classification technique. The static object can be, for example, but not limited to a floor (502b), ceiling and wall (502a). The dynamic object can be, for example, but not limited to people (504a) in the XR scene, a movable furniture, and objects that are not fixated to furniture.

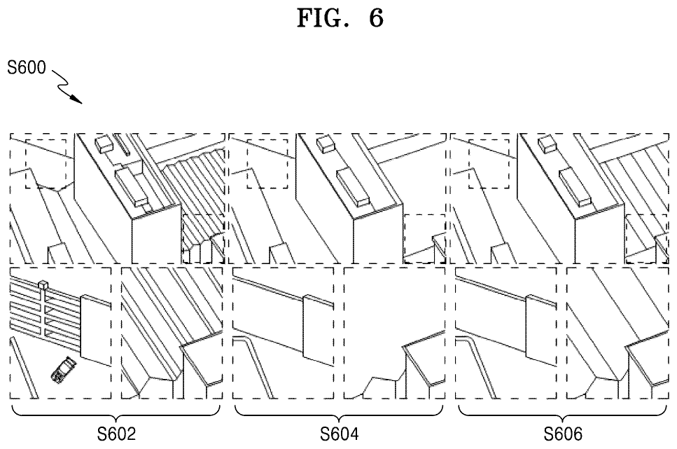

FIG. 6 is an example illustration (S600) in which the surface mapping is depicted, according to an embodiment of the disclosure. The surface mapping jointly refines the geometry and semantics of labelled 3D surfaces meshes. The scene image is shown in label S602, an input model is shown in label S604, and an output result after performing geometric and semantic surface refinement is shown in label S606.

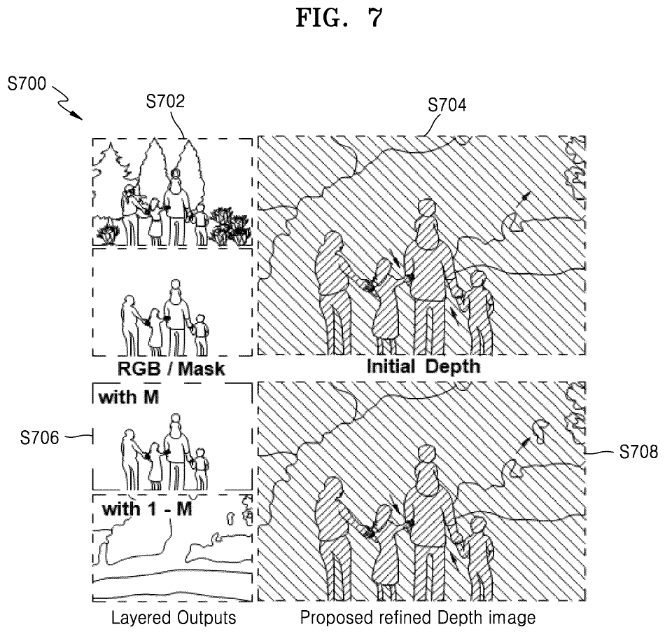

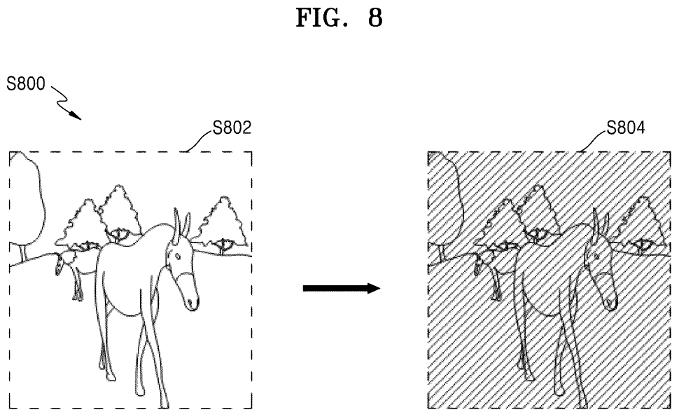

FIGS. 7 and 8 are example illustrations (S700 and S800) in which depth mapping is depicted, according to various embodiments of the disclosure. The depth map can be an image channel that contains information relating to a distance of the surfaces of the XR scene objects from a viewpoint. The depth mapping can be used to enhance an inter-view consistency of the depth maps. Only information from the depth maps is used, as the use of texture can introduce errors in refinement, mostly due to inter-view colour inconsistencies and noise.

Referring to FIG. 7, the input image (S702) is provided as a RGB image and/or a mask image. Based on the RGB image and/or a mask image, the initial depth image (S704) is obtained and layered outputs (S706) are obtained for the initial depth image (S704) and finetune to get the proposed refined depth image (S708).

Referring to FIG. 8, the static objects are trees and the dynamic objects are the moving horse. The depth map refinement is done by obtaining the tree information from the contextual database (130) and the refining for the moving horse. The input image is shown in label S802 and the output depth image is shown in label S804.

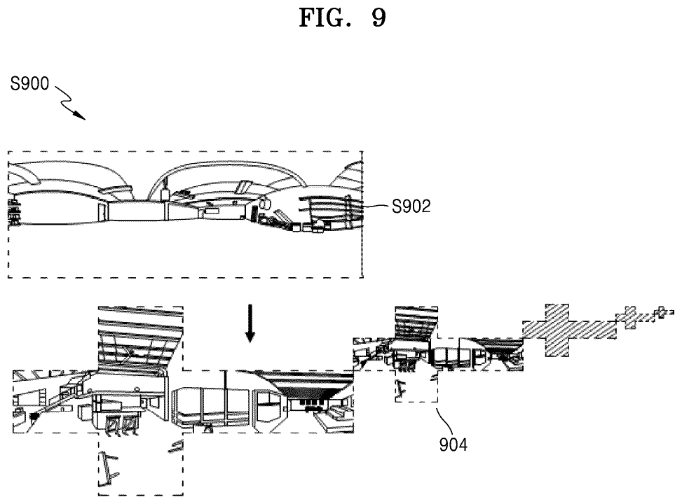

FIG. 9 is an example illustration (S900) in which light mapping (or an environmental mapping) is depicted, according to an embodiment of the disclosure. The light map associated the image (S904) is obtained from the initial image (S902).

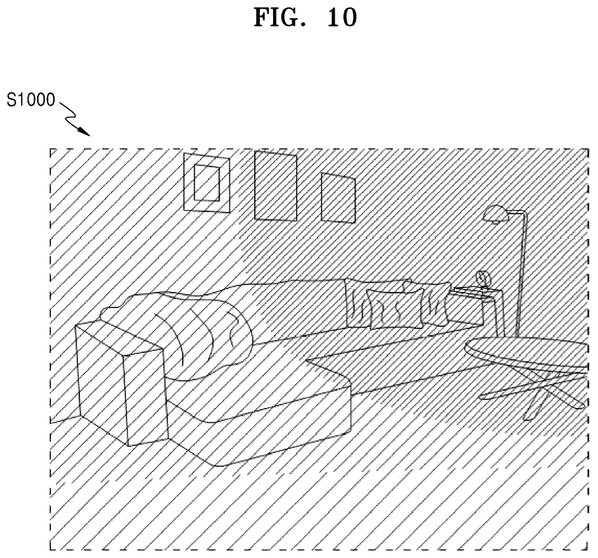

FIG. 10 is an example illustration (S1000) in which the spatial mapping is depicted for the XR environment including the furniture, wall, and window, according to an embodiment of the disclosure. The spatial mapping provides a detailed representation of real-world surfaces in the XR environment so as to create a convincing mixed reality experience. By merging the real world information with the virtual world information, an XR application can make XR seem real. The XR applications can more naturally align with user expectations by providing familiar real-world behaviors and interactions.

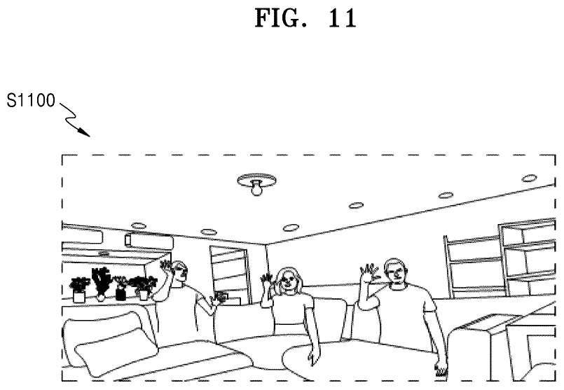

FIG. 11 is an example illustration (S1100) in which the proposed method is implemented in an indoor meeting room setup, according to an embodiment of the disclosure. The AR application running in the AR device scans a virtual conference room environment (or indoor meeting room setup) to determine the visual features (e.g., number of users, a type of table, a type of laptop, furniture or the like) of the virtual conference room environment and a frequency usage of the virtual conference room environment. Further, the AR device allows the user to store the pre-store AR data for the most frequently used location. The AR data can be, for example, but not limited to the surface map associated with the visual features, the depth map associated with the visual features, the object maps, the scene graph, the semantic information, and the pre computed lighting. Further, the user of the AR device provides additional information (e.g., day, time, season information or the like). Based on the AR data and the additional information, the AR device matches the visual features by querying the contextual database (130) and retrieving the AR data. Further, the AR device progressively refines the AR data based on current scene context. Further, the AR device creates the database profile including the user information and the location for providing the enhanced user experience for the repeated usage.

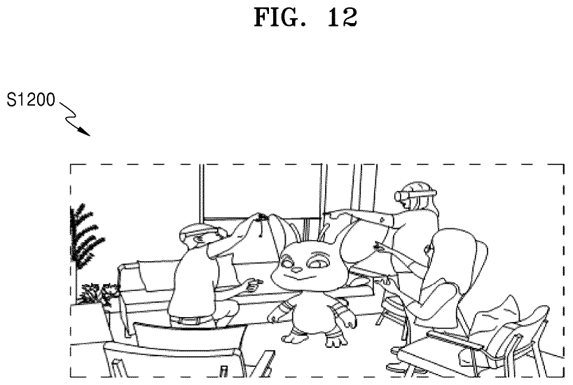

FIG. 12 is an example illustration (S1200) in which the proposed method is implemented in an interactive sculpting application, according to an embodiment of the disclosure. The AR application running in the AR device scans an indoor room setup to determine the visual features (e.g., number of users, a type of table, furniture or the like) of the indoor room setup and the frequency usage of the indoor room setup. Further, the AR device allows the user to store the pre-store AR data for the most frequently used location. The AR data can be, for example, but not limited to the surface map associated with the visual features, the depth map associated with the visual features, the object maps, the scene graph, the semantic information, and the pre-computed lighting. Further, the user of the AR device provides the additional information (e.g., day, time, season information or the like). Based on the AR data and the additional information, the AR device matches the visual features by querying the contextual database (130) and retrieving the AR data. Further, the AR device progressively refines the AR data based on the current scene context. Further, the AR device creates the database profile including the user information and the location for providing the enhanced user experience for the repeated usage.

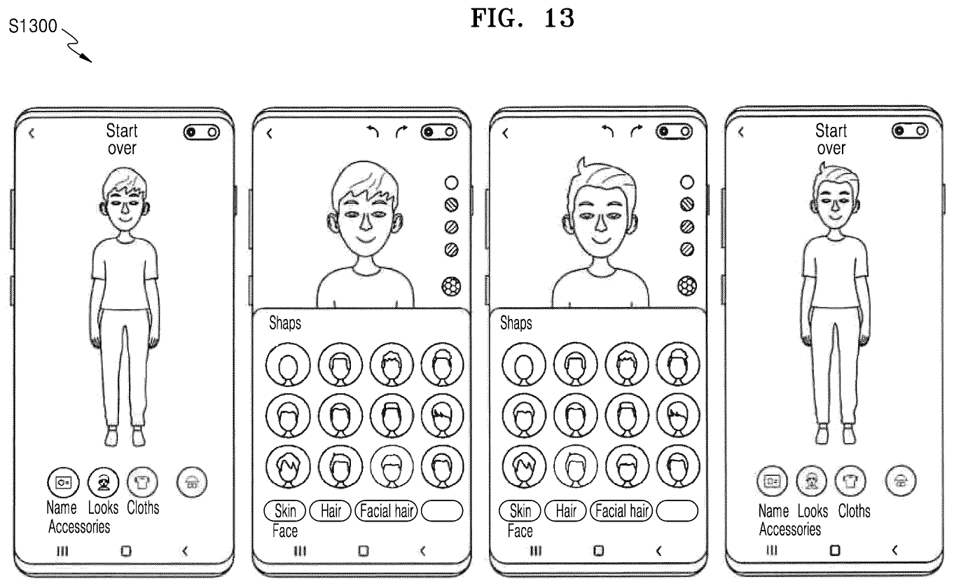

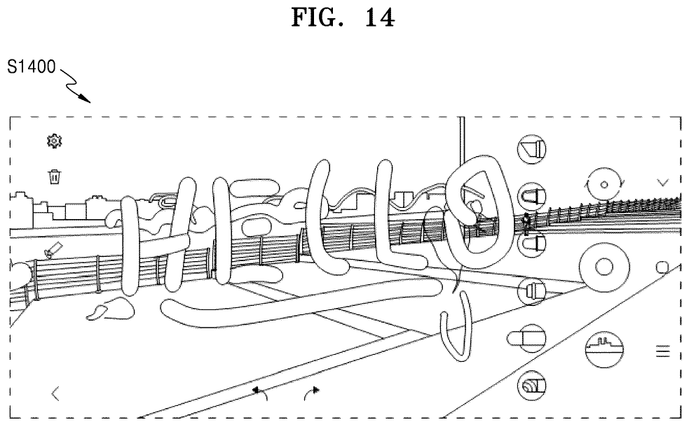

FIG. 13 is an example illustration (S1300) in which the proposed method is implemented in AR emoji play mode, according to an embodiment of the disclosure. FIG. 14 is an example illustration (S1400) in which the proposed method is implemented in an AR Doodle application, according to an embodiment of the disclosure.

Referring to FIGS. 13 and 14, the user of the electronic device (100) starts a XR session. Upon starting the XR session, the contextual database (130) stores the meta Information along with the user, the location, and the time information. For the subsequent sessions, the contextual database (130) is checked for the user. When there is a match with the user, then the meta information from the previous session is used and refinement of dynamic information for the current session is done. Further, the quality rendering is done with performance enhancements. Further, the electronic device (100) stores the mapping in the contextual database (130) based on a policy and the current user. When there is not a match with the user, the electronic device (100) creates a new session.

The electronic device (100) detects the static object and the dynamic object in the XR scene. Further, the electronic device (100) determines the context information of the dynamic object. Further, the electronic device (100) displays a complete rendering of the dynamic object in the XR scene by applying the contextual meta information to the dynamic object in the XR scene, when the correlation between the context information of the dynamic object and the contextual meta information corresponding to the dynamic object is available in the contextual database (130). The proposed method can be used to provide better performance and quality for contextual based enhancement of the XR scene.

In an embodiment, the method includes determining, by the electronic device, a plurality of objects available in the XR scene for a predefined time period. The XR scene is associated with a predefined area comprising the plurality of objects. Further, the method includes determining, by the electronic device, the contextual meta information of each object of the plurality of objects. Further, the method includes storing, by the electronic device, the contextual meta information of each object of the plurality of objects in the contextual database.

In an embodiment, displaying the complete rendering of the dynamic object in the XR scene by applying the contextual meta information to the dynamic object in the XR scene includes retrieving, by the electronic device, the contextual meta information from the contextual database based on the correlation, where the contextual meta information includes a surface map having a three-dimensional (3D) reconstructed surface of the XR scene, a depth map having depth information of the XR scene, and a light map (or an environmental map) for the dynamic object, refining, by the electronic device, the surface map, the depth map, and the light map based on the context information of the dynamic object, and displaying, by the electronic device, the complete rendering of the dynamic object in the XR scene by applying the refined surface map, the refined depth map, and the refined light map to the dynamic object in the XR scene.

In an embodiment, further, method includes storing, by the electronic device, the refined surface map, the refined depth map, and the refined light map of the dynamic object in the XR scene in the contextual database.

In an embodiment, the context information includes a current time, a location, a lighting condition, and user information.

In an embodiment, detecting, by the electronic device, the static object and the dynamic objects in the XR scene includes detecting, by the electronic device, a plurality of parameters associated with each object of the plurality of objects in the XR scene, where the plurality of parameters includes a type of object, and movements of the object in the XR scene and determining, by the electronic device, the dynamic objects from the plurality of objects based on the plurality of parameters, and the static object from the plurality of objects when no movements are detected.

In and embodiment, a method for contextual rendering of extended reality (XR) scene in an electronic device is provided. The method includes identifying, by the electronic device, at least one static object and at least one dynamic object in the XR scene. Further, the method includes determining, by the electronic device, a context information comprising at least one of a current time, a location, and a lighting in connection with the at least one dynamic object in the XR scene. Further, the method includes obtaining, by the electronic device, a correlation of the context information and a contextual meta information including at least one of a surface map, a texture, and a light map for the at least one dynamic object from a contextual database. Further, the method includes applying, by the electronic device, the obtained contextual meta information from the database on to the at least one dynamic object for rendering the XR scene.

In an embodiment, an electronic device for contextual rendering of XR scene is provided. The electronic device includes a contextual meta information controller communicatively coupled to a contextual database and a processor. The contextual meta information controller is configured to identify at least one static object and at least one dynamic object in the XR scene. The contextual meta information controller is configured to determine a context information comprising at least one of a current time, a location, and a lighting in connection with the at least one dynamic object in the XR scene. The contextual meta information controller is configured to obtain a correlation of the context information and a contextual meta information including at least one of a surface map, a texture, and a light map for the at least one dynamic object from a contextual database. The contextual meta information controller is configured to apply obtained contextual meta information from the database on to the at least one dynamic object for rendering the XR scene.

In an embodiment, the context information includes at least one of a current time, a location and a lighting condition, wherein the contextual meta information includes a surface map of the XR scene, a depth map of the XR scene and a light map of the XR scene.

In an embodiment, in case that the correlation between the context information of the at least one dynamic object and the contextual meta information corresponding to the at least one dynamic object is not available in the contextual database, the method includes displaying a partial rendering of the at least one dynamic object in the XR scene by applying non-contextual meta information of the at least one dynamic object.

In an embodiment, the method includes determining a plurality of objects available in the XR scene for a predefined time period, wherein the XR scene is associated with a predefined area comprising the plurality of objects, determining the contextual meta information of each object of the plurality of objects, and storing the contextual meta information of each object of the plurality of objects in the contextual database.

In an embodiment, the method includes displaying a complete rendering of the at least one dynamic object in the XR scene by applying the contextual meta information to the at least one dynamic object in the XR scene, retrieving the contextual meta information from the contextual database based on the correlation, wherein the contextual meta information comprises at least one of a surface map having three-dimensional (3D) reconstructed surface of the XR scene, a depth map having depth information of the XR scene, and a light map for the at least one dynamic object, refining the surface map, the depth map, and the light map based on the context information of the at least one dynamic object and displaying the complete rendering of the at least one dynamic object in the XR scene by applying the refined surface map, the refined depth map, and the refined light map to the at least one dynamic object in the XR scene.

In an embodiment, the method includes storing the refined surface map, the refined depth map, and the refined light map of the at least one dynamic object in the XR scene in the contextual database.

In an embodiment, wherein the context information comprises at least one of a current time, a location, a lighting condition, and user information.

In an embodiment, the method includes detecting a plurality of parameters associated with each object of a plurality of objects in the XR scene, wherein the plurality of parameters comprises a type of object, and movements of the object in the XR scene and determining the at least one dynamic object from the plurality of objects based on the plurality of parameters, and the at least one static object from the plurality of objects when no movements are detected.

In an embodiment, in case that the correlation between the context information of the at least one dynamic object and the contextual meta information corresponding to the at least one dynamic object is available in the contextual database, the method includes displaying a complete rendering of the at least one dynamic object in the XR scene by applying contextual meta information to the at least one dynamic object in the XR scene. The various actions, acts, blocks, steps, or the like in the flow charts at operations S200-S400 may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for contextual based enhancement of an extended reality (XR) scene in an electronic device, comprising:
detecting at least one static object and at least one dynamic object in an XR scene;
determining context information of the at least one dynamic object;
determining whether a correlation between the context information of the at least one dynamic object and contextual meta information corresponding to the at least one dynamic object is available in a contextual database; and
applying the contextual meta information from the contextual database to the at least one dynamic object.

2. The method of claim 1, wherein the context information includes at least one of a current time, a location and a lighting condition, wherein the contextual meta information includes a surface map of the XR scene, a depth map of the XR scene and a light map of the XR scene.

3. The method of claim 1, further comprising:
in case that the correlation between the context information of the at least one dynamic object and the contextual meta information corresponding to the at least one dynamic object is not available in the contextual database, displaying a partial rendering of the at least one dynamic object in the XR scene by applying non-contextual meta information of the at least one dynamic object.

4. The method of claim 1, further comprising:
determining a plurality of objects available in the XR scene for a predefined time period, wherein the XR scene is associated with a predefined area comprising the plurality of objects;
determining the contextual meta information of each object of the plurality of objects; and
storing the contextual meta information of each object of the plurality of objects in the contextual database.

5. The method of claim 1, further comprising:
displaying a complete rendering of the at least one dynamic object in the XR scene by applying the contextual meta information to the at least one dynamic object in the XR scene;
retrieving the contextual meta information from the contextual database based on the correlation, wherein the contextual meta information comprises at least one of a surface map having three-dimensional (3D) reconstructed surface of the XR scene, a depth map having depth information of the XR scene, and a light map for the at least one dynamic object;
refining the surface map, the depth map, and the light map based on the context information of the at least one dynamic object; and
displaying the complete rendering of the at least one dynamic object in the XR scene by applying the refined surface map, the refined depth map, and the refined light map to the at least one dynamic object in the XR scene.

6. The method of claim 5, further comprising:
storing the refined surface map, the refined depth map, and the refined light map of the at least one dynamic object in the XR scene in the contextual database.

7. The method of claim 1, wherein the context information comprises at least one of a current time, a location, a lighting condition, and user information.

8. The method of claim 1, wherein the detecting the at least one static object and the at least one dynamic object in the XR scene comprises:
detecting a plurality of parameters associated with each object of a plurality of objects in the XR scene, wherein the plurality of parameters comprises a type of object, and movements of the object in the XR scene; and
determining the at least one dynamic object from the plurality of objects based on the plurality of parameters, and the at least one static object from the plurality of objects when no movements are detected.

9. The method of claim 1, further comprising:
in case that the correlation between the context information of the at least one dynamic object and the contextual meta information corresponding to the at least one dynamic object is available in the contextual database, displaying a complete rendering of the at least one dynamic object in the XR scene by applying contextual meta information to the at least one dynamic object in the XR scene.

10. An electronic device for contextual based enhancement of an XR scene, comprising:
a display including a touchscreen;
memory storing one or more computer programs; and
one or more processors communicatively coupled to the display, and the memory,
wherein the one or more computer programs include computer-executable instructions that, when executed by the one or more processors, cause the electronic device to:
detect at least one static object and at least one dynamic object in an XR scene,
determine context information of the at least one dynamic object,
determine whether a correlation between the context information of the at least one dynamic object and contextual meta information corresponding to the at least one dynamic object is available in a contextual database stored in the memory, and
apply the contextual meta information from the contextual database to the at least one dynamic object.

11. The electronic device of claim 10, wherein the one or more computer programs further include computer-executable instructions that, when executed by the one or more processors, cause the electronic device to:
in case that the correlation between the context information of the at least one dynamic object and the contextual meta information corresponding to the at least one dynamic object is not available in the contextual database, display, on the display, a partial rendering of the at least one dynamic object in the XR scene by applying non-contextual meta information of the at least one dynamic object.

12. The electronic device of claim 10, wherein the one or more computer programs further include computer-executable instructions that, when executed by the one or more processors, cause the electronic device to:
determine a plurality of objects available in the XR scene for a predefined time period, wherein the XR scene is associated with a predefined area comprising the plurality of objects;
determine the contextual meta information of each object of the plurality of objects; and
store the contextual meta information of each object of the plurality of objects in the contextual database.

13. The electronic device of claim 10, wherein the one or more computer programs further include computer-executable instructions that, when executed by the one or more processors, cause the electronic device to:
display, on the display, a complete rendering of the at least one dynamic object in the XR scene by applying the contextual meta information to the at least one dynamic object in the XR scene;
retrieve the contextual meta information from the contextual database based on the correlation, wherein the contextual meta information comprises at least one of a surface map having three-dimensional (3D) reconstructed surface of the XR scene, a depth map having depth information of the XR scene, and a light map for the at least one dynamic object;
refine the surface map, the depth map, and the light map based on the context information of the at least one dynamic object; and
display, on the display, the complete rendering of the at least one dynamic object in the XR scene by applying the refined surface map, the refined depth map, and the refined light map to the at least one dynamic object in the XR scene.

14. The electronic device of claim 13, wherein the one or more computer programs further include computer-executable instructions that, when executed by the one or more processors, cause the electronic device to:
store the refined surface map, the refined depth map, and the refined light map of the at least one dynamic object in the XR scene in the contextual database.

15. The electronic device of claim 10, wherein the context information comprises at least one of a current time, a location, a lighting condition, and user information.

16. The electronic device of claim 10, wherein the one or more computer programs further include computer-executable instructions that, when executed by the one or more processors, cause the electronic device to:
detect a plurality of parameters associated with each object of a plurality of objects in the XR scene, wherein the plurality of parameters comprises a type of object, and movements of the object in the XR scene; and
determine the at least one dynamic object from the plurality of objects based on the plurality of parameters, and the at least one static object from the plurality of objects when no movements are detected.

17. The electronic device of claim 10, wherein the one or more computer programs further include computer-executable instructions that, when executed by the one or more processors, cause the electronic device to:
in case that the correlation between the context information of the at least one dynamic object and the contextual meta information corresponding to the at least one dynamic object is available in the contextual database, display, on the display, a complete rendering of the at least one dynamic object in the XR scene by applying contextual meta information to the at least one dynamic object in the XR scene.

18. The electronic device of claim 10, wherein the one or more processors includes a processor and a contextual meta information controller.

19. The electronic device of claim 10, wherein the contextual database is stored in the memory as a binary large object (BLOB) storage, a file system storage, or a Base64 encoding storage.

20. One or more non-transitory computer-readable storage media storing one or more computer programs including computer-executable instructions that, when executed by one or more processors of an electronic device, cause the electronic device to perform the method of claim 1.
